(19) United States
(12) Patent Application Publication
(10) Pub. No.: US 2018/0242731 A1
(43) Pub. Date: Aug. 30, 2018

(54) MULTIMEDIA TABLE

(71) Applicant: RE MAGO SA, Lugano (CH)

(72) Inventor: Luca PIZZINATO, Varese (VA) (IT)

(21) Appl. No.: 15/757,610

(22) PCT Filed: Sep. 30, 2015
(86) PCT No.: PCT/IB2015/001743

§ 371 Date: Mar. 5, 2018

(30) Foreign Application Priority Data
Sep. 4, 2015 (IT) 102015000048494

(51) Int. Cl. A47B 21/06; F16B 12/44; A47B 13/00; H01R 33/46; H01R 33/90

(52) U.S. Cl. CPC A47B 21/06; F16B 12/44; A47B 13/003; H01R 33/46; F16B 2012/446; A47B 2013/006; A47B 2021/066; A47B 2200/0019; H01R 33/90

(57) ABSTRACT

A multimedia table is provided with a work top set up for the association with a multimedia unit and supported by a plurality of legs. At each supporting leg the work top includes the first part of a bayonet fitting, separable in two parts, whereas the second part is arranged on the facing surface of the corresponding leg, and at least one of the table legs is provided with wires, extending between the second bayonet fitting part and the foot of the leg for the connection of the multimedia unit to the power supply networks available close to the aforementioned leg.

The invention relates to the field of office furniture, and more specifically to tables. Hereinafter in the present description, the word “table” includes a table with three or more legs, preferably with four legs, which must be oriented in any manner in a working environment and connected to a power dock fixed to the room floor, which supplies the electric energy and the online connection to the aforesaid table for allowing the activity of the various multimedia instruments arranged on the table. A professional workstation without at least one monitor on the table connected to a computer and to a number of auxiliary devices for interacting with said monitor is unimaginable today. For architects, engineers, lawyers, doctors and accountants, to name a few known professions, computers and the respective information technology systems have become irreplaceable means for dealing with and solving everyday work problems. In order to meet these needs, so-called computerized tables have been created, i.e. tables provided with multimedia instruments on the work top, and in some cases even under said work top, in this case provided with missing or transparent portions, to allow the monitor(s) placed under the work top to be viewed. Increasingly more often the multimedia instruments are arranged on the table according to a specifically studied, predetermined layout, which cannot be altered as desired, and are connected to the electric power supply and to the online connection of the aforesaid dock by means of a leg, which in addition to being the supporting leg is also provided with wires and ports, needed to ensure the connection of said instruments to the respective power supply networks leading to the dock. However, with use, it is noted that these tables are often the source of annoyances which are not easily overcome. Indeed, the position of a multimedia table in a room must be chosen considering the position of the windows, because the light coming from the outside may make reading the monitor difficult, and the purpose of the room, in particular if it is intended to host people, because the table leg which supplies the instruments is often the farthest from the power dock, which is in a fixed position on the floor, with the drawback of having multimedia junction boxes and cables which are dangerous obstacles on the floor. Given the above, the Applicant has devised an invention which solves the above-described drawbacks facilitating the choice of positioning the table(s) in the working environment, and so the work of the professional who can operate in a comfortably equipped area.

Therefore, it is the object of the invention a multimedia table which allows an orientation in the working environment with elimination of the multitude of cables and connections laying on the floor for connecting said instruments to one another and to the dock carrying the external networks.

In a more general aspect, the invention thus relates to a multimedia table provided with a work top set up for the association with multimedia means and supported by a plurality of legs, characterized in that at each supporting leg said work top comprises the first part of a bayonet fitting, separable in two parts, whereas the second half is arranged on the facing surface of the corresponding leg, one of said legs being provided with wires, extending between said facing surface and the foot of said leg for the connection of said multimedia means to power supply networks available close to said leg.

Preferably said bayonet fitting is of the type which mutually connects a first female half to a second male half, and said first female half is integral with said work top.

Further features and advantages of the invention will become more apparent from the detailed description of a preferred, but not exclusive embodiment of said table according to the present invention and in particular with reference to the solution in which a technological leg is used.

Such a description will be illustrated hereinafter with reference to a specific embodiment of said table, for which the accompanying drawings are provided by way of explanatory, and thus non-limitative example, in which:

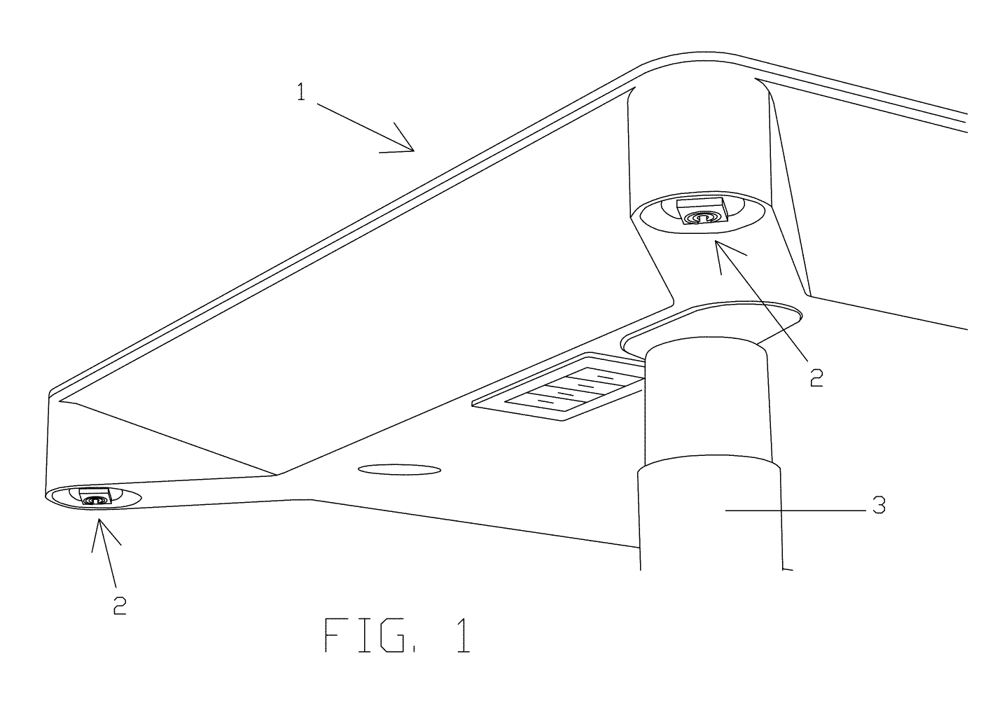

FIG. 1 shows an end of the table of the invention according to the short side, which comprises, close to each end angle, a cavity in which the corresponding supporting leg is inserted;

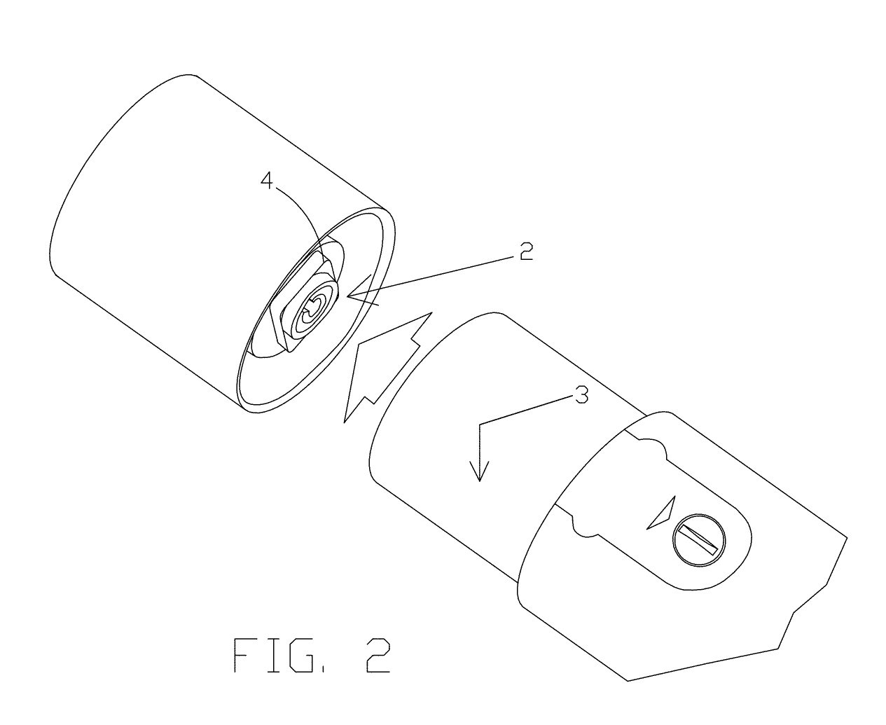

FIG. 2 shows the first end of a bayonet fitting inserted in an angle cavity of the table in FIG. 1, integral therewith;

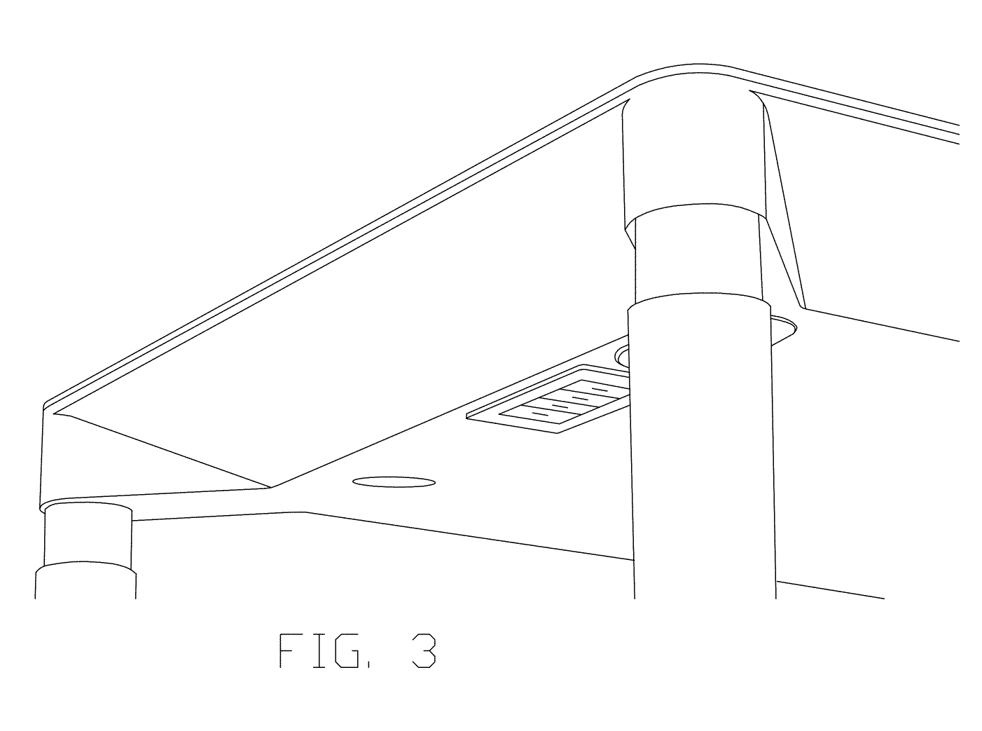

FIG. 3 shows two adjacent legs of the table at the beginning of the approach of the leg to the cavity of the table in FIG. 1;

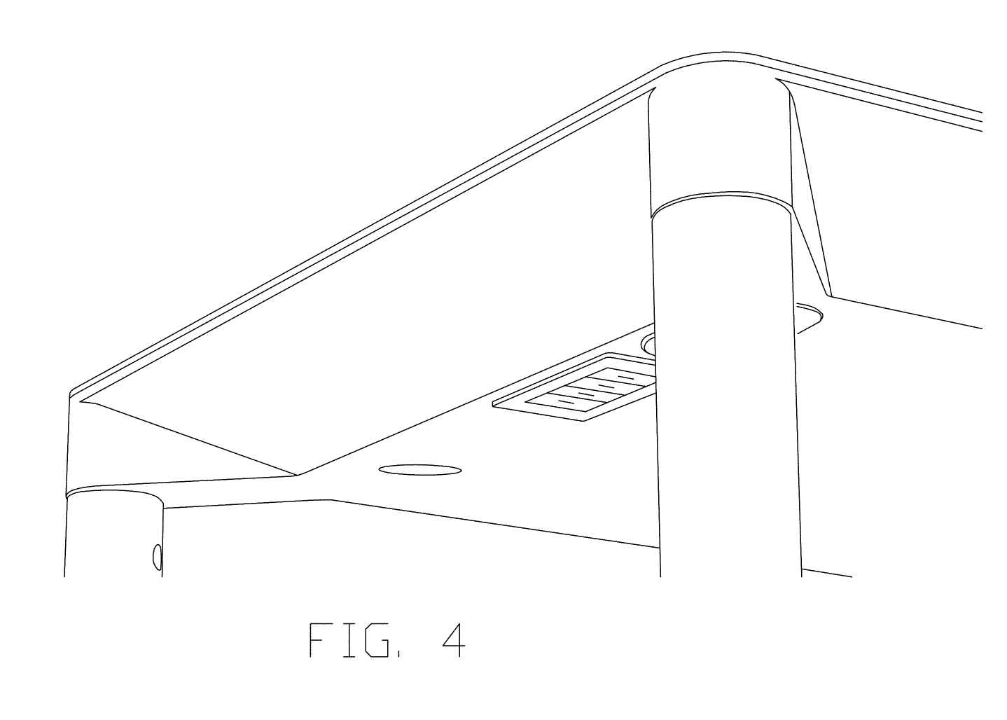

FIG. 4 shows the two legs of the table at the end of the reciprocal axial approach;

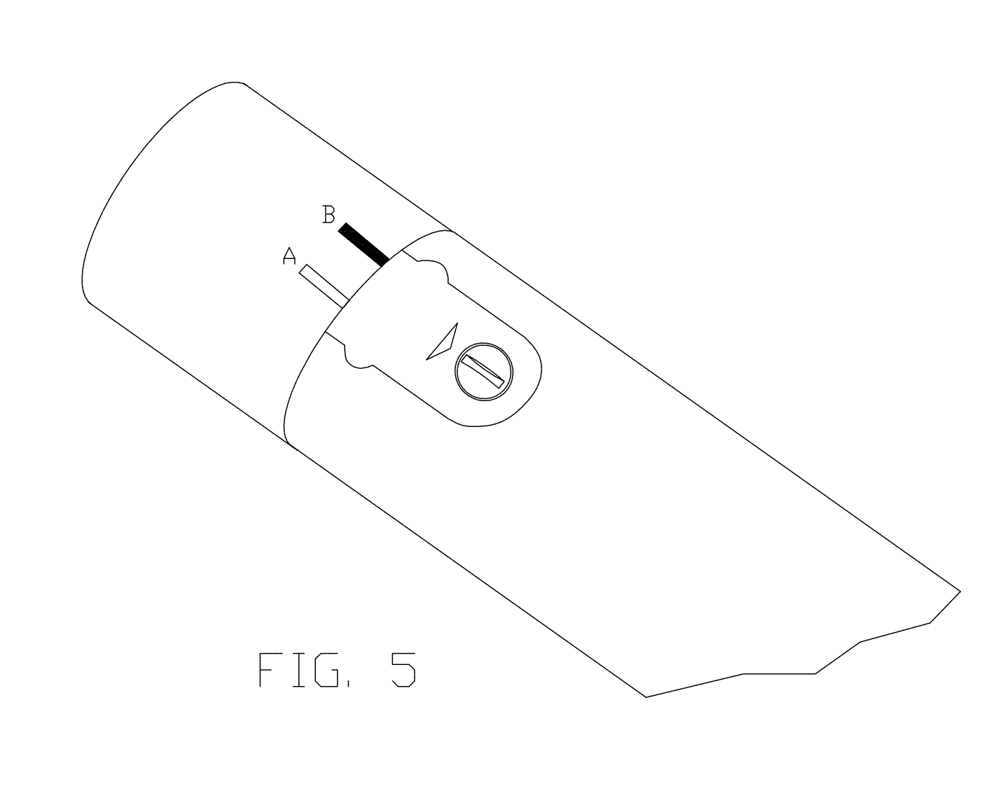

FIG. 5 shows a leg of the table before the relative rotation respect to the cavity of the table;

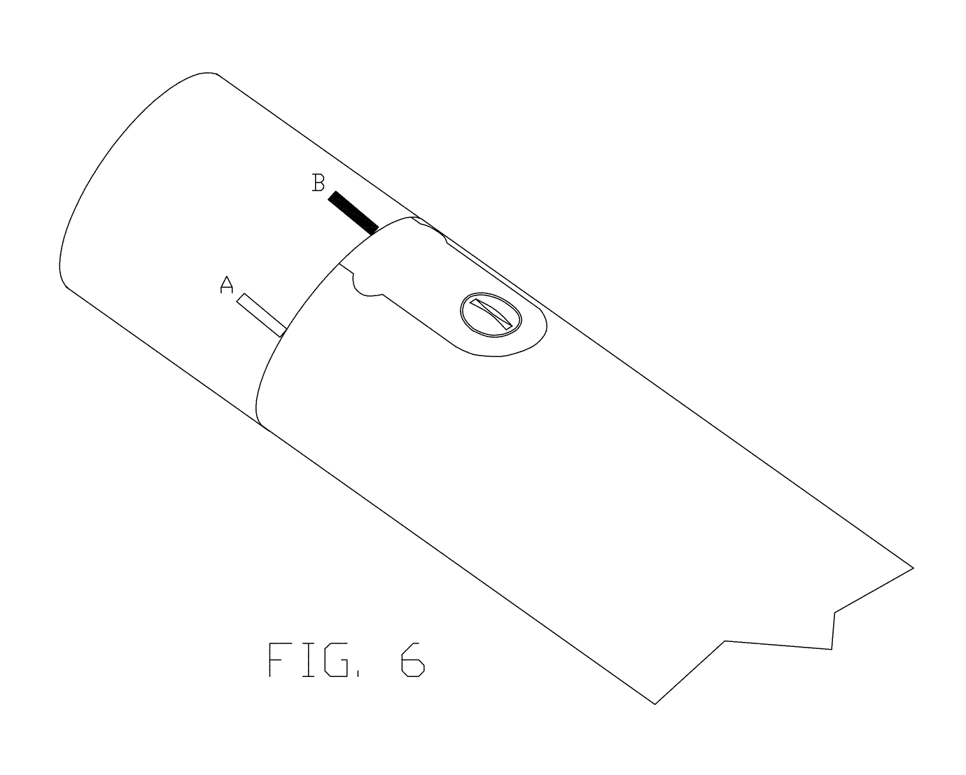

FIG. 6 shows the leg in FIG. 5 at the end of the relative rotation with respective to the table cavity;

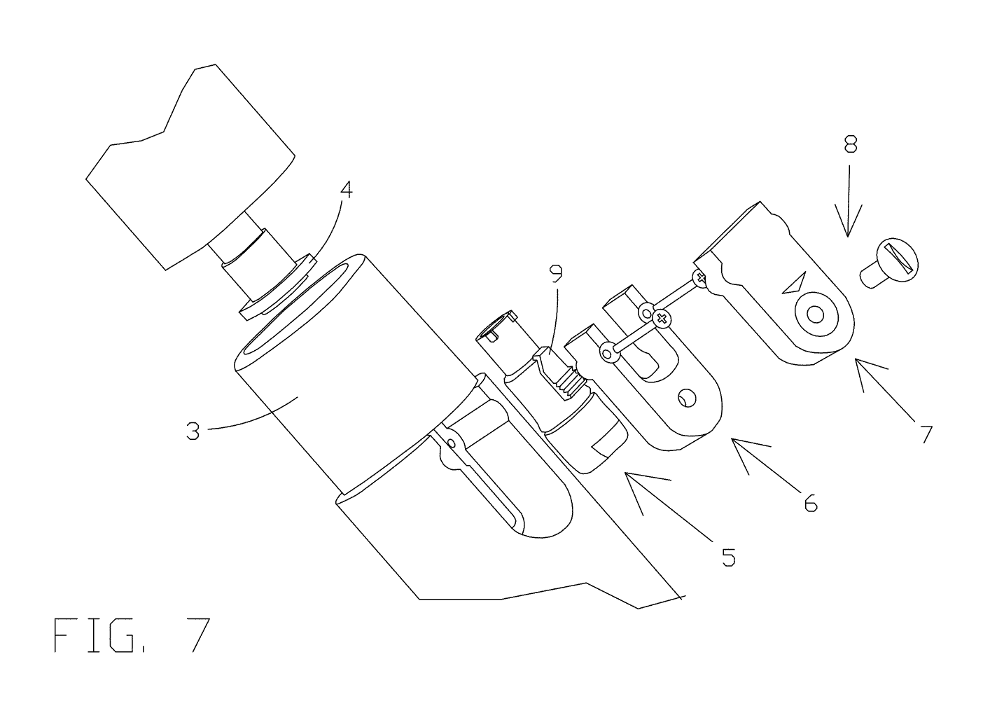

FIG. 7 shows an exploded view of the component parts of the bayonet fitting mounted on the table and on the leg, respectively;

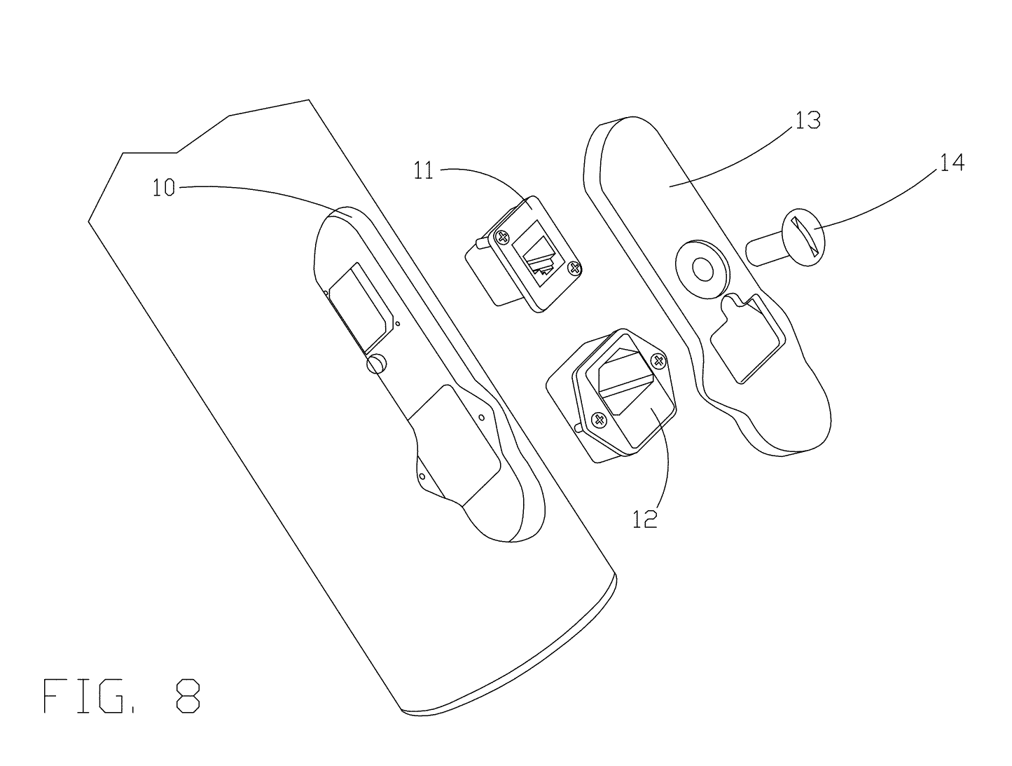

FIG. 8 shows a technological leg, having tubular structure, provided, at the foot, with a radial slot in which a connector for the data transmission network, a connector for the electric power supply network and a protection lid fixable to the leg by means of a screw are housed;

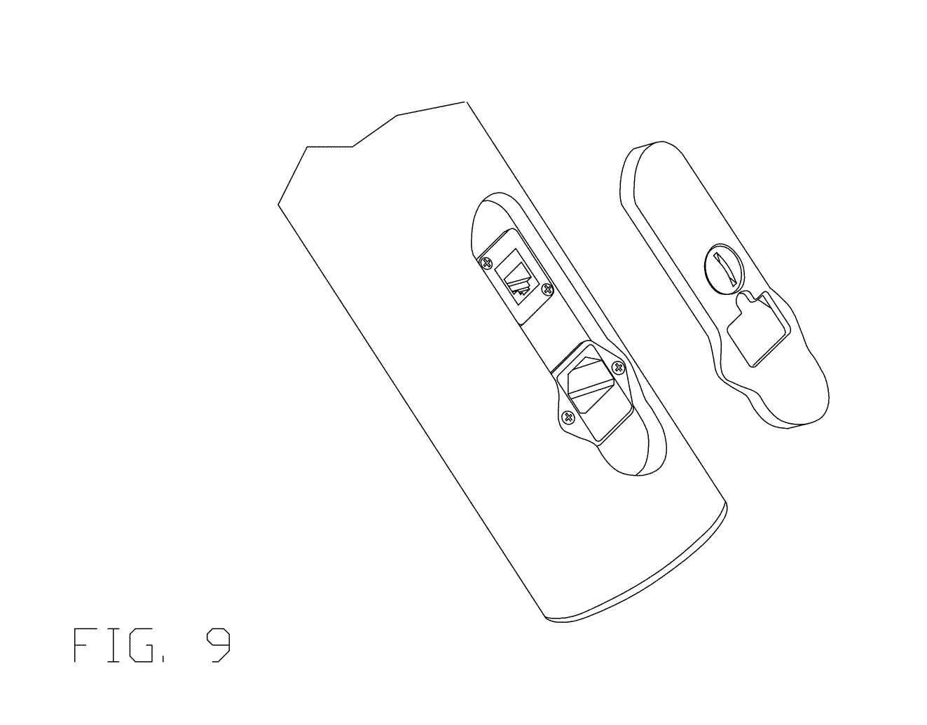

FIG. 9 shows the foot of the technological leg with the connectors and the respective protective cap;

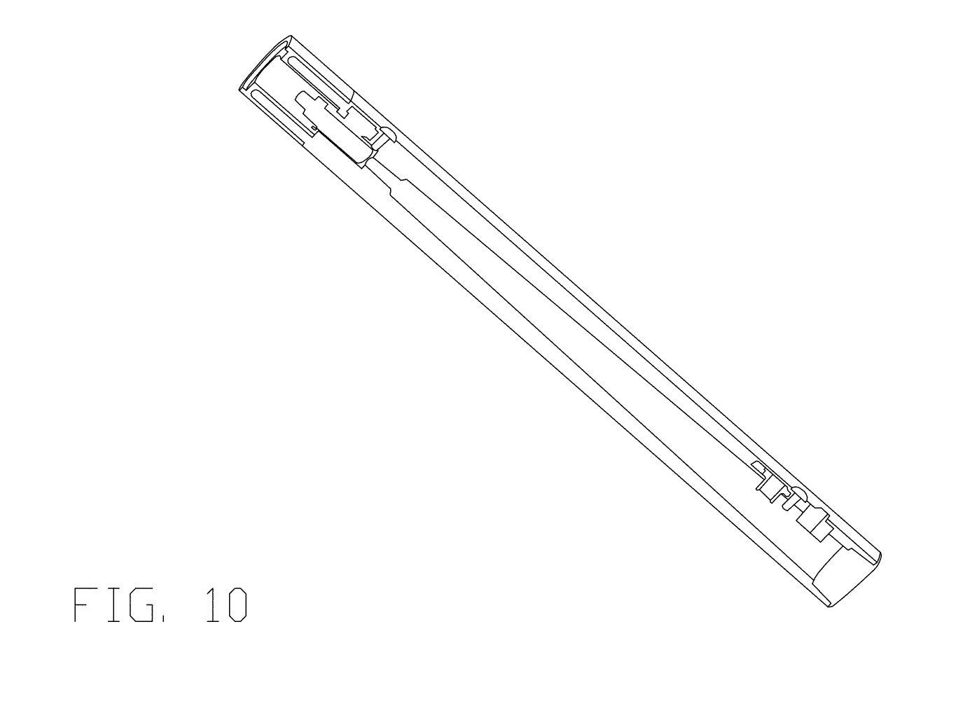

FIG. 10 shows the technological leg as a whole.

The invention is described for simplicity with reference to a four-legged rectangular table without this being a limitation of any type with regards to the effects of the embodiments of the invention. FIG. 1 shows an end of the table of the invention according to the short side in a preferred embodiment which comprises a work top 1, which close to each end has a cavity 2 in which the corresponding supporting leg 3 is inserted, as described below. The table is arranged in the environment so that there is a power supply dock for supplying the necessary services for the table, protruding from the floor in a predetermined position, close to the foot of one of the legs.

The shape of the table and the number of legs is absolutely not a limitation for the invention, for example there could be a table supported by only three legs or a table present of elongated rectangular shape supported by six or more legs in a meeting room.

The work top of the aforesaid table is set up for the association with multimedia means stably fixed to the work top, so that the table cannot be oriented as desired in the environment having regard to the position of the lights, the windows and the other furniture.

At each supporting leg of the work top, there is the first half of a bayonet fitting, of the type separable in two parts, the second part being arranged on the facing surface of the corresponding leg, in each cavity 2. FIG. 2 shows the first half 4 of said fitting inserted in the cavity 2, and integral therewith, while the second half 5 is concealed within the leg 3. This fitting is not described in detail here because it is one of the many usable types of known fittings. In particular, the fitting type used in the Applicant's realization comprises two reciprocally separable parts, one (4) referred to as female, the other (5) referred to as male, which are coupled to each other by means of a reciprocal approach followed by a relative rotation, at the end of which the coupling of the two components parts is stable and integral. The male part 5 comprises the device which allows to uncouple the two parts from each other, which parts are then separable by means of a rotation and a reversed axial movement.

The solution in which the female part 4 is mounted on the table and the male part 5 is mounted on the leg was preferred in the embodiment implemented by the Applicant although the positions can be mutually reversed.

FIG. 3 shows two adjacent legs of the table at the beginning of the approach between the two parts of the bayonet fitting with the insertion of the leg in the cavity 2. FIG. 4 shows the two legs of the table at the end of the reciprocal axial approach. FIGS. 5 and 6 show a leg of the table at the beginning of the respective rotation and at the end of said rotation. The entity of the rotation is shown by the width of the arc of circle between references A and B.

FIG. 7 shows an exploded view of the component parts of the bayonet fitting mounted on the table and on the leg, respectively.

With reference to the work top (not shown), the female connector 4 protrudes from the cavity 2, while the male connector 5 coaxial to the female connector, a locking device 6 of the connector within the leg and a protective cap 7 of the entire device fixed to the table leg with a screw 8 are inserted inside the leg 3, radially proceeding from the inside outwards. The release tooth 9 for opening the fitting is visible on the male connector. From the above, it is easy to comprehend that the legs of the table are mutually interchangeable. The work top is provided with wires for supplying the multimedia devices associated with the table which mutually connect in parallel all the cavities provided in the corners of said table in which connection devices for the connection to the cables inserted in the technological leg are housed, as shown below.

However, preferably according to the invention, the aforesaid wires arranged in the work top are connected to the halves of the bayonet fitting devices provided on said table. Again according to the invention, at least one of the legs, but preferably only one of said legs, is different from the others. Indeed, at least one of the supporting legs, referred to as “technological leg”, is provided with wires extending between said second bayonet fitting half and the foot of the leg in which the devices for connecting the multimedia means arranged on the work top to power supply networks available in the docks emerging from the floor are arranged.

FIG. 8 shows this technological leg in greater detail. The aforesaid leg, made of any suitable material, has a tubular, preferably cylindrical structure and has, at the foot, a radial slot 10 within which a connector 11 for the data transmission network, a connector 12 for the electric power supply network and a protective lid 13 fixable to the leg by means of a screw 14 are housed.

FIG. 9 shows the foot of the technological leg with the connectors fitted in their seat and the respective protective cap arranged by the side of the foot and not yet mounted in its seat. FIG. 10 shows the technological leg as a whole. The wires which mutually connect the connectors mounted in the foot of the leg and the connection devices connectable to the connection devices mounted in the angular cavities of the table run in the longitudinal cavity of the tubular structure. However, preferably similarly to that described above, the aforesaid wires are directly connected to the second part of the fitting device.

Such wires allow the connection of the multimedia devices placed on the table to at least one external electric power supply network and to at least one external data transmission network, made available on the dock usually fixed to the floor. Preferably, the connectors placed at the foot of the technological leg comprise so-called USB ports, which are well-known in information technology.

Even more preferably, the data transmission network connectors are RJ45 connectors. Conversely, again according to the invention, the electric connection and the data transmission connection are guaranteed on the top of the leg which is inserted in the corresponding cavity of the table by the two halves of the bayonet fitting device, so that the fitting device simultaneously provides both the mechanical attachment and the electric connection and/or the data connection. In other words, the mechanical part of the device contributes to the electric conduction.

The invention solves the illustrated problem and achieves various advantages. The multimedia table may be oriented in the destination room in the most convenient manner having regard to ergonomic requirements and to the constraints posed by the presence of other pieces of furniture. The technological leg will be fixed to the table in the position closest to the service dock, fixed to the floor, without any problem because all the legs may be fixed in each of the cavities provided on the table and all the cavities can supply the multimedia devices associated with the table. The substantial ineffectiveness of having technological versions of all table legs is apparent, given their interchangeability, with the consequent considerable economic advantage.

Further advantages are offered by the presence of the technological leg: no need for wandering cables on the floor or the presence of technological boxes under the table: which table leg needs to be the technological one can be decided during the step of purchasing and ordering of the table, so as to minimize the distance between leg and dock according to the room layout and the position of the power docks.

As a rule, the present description does not illustrate all the possible structural and dimensional alternatives of the specifically described embodiments of the invention: indeed, it was deemed unnecessary to explain the constructive details of the system of the invention extensively because given the instructions provided herein anyone skilled in the art will have no difficulty to design the most advantageous technical solution by appropriately choosing materials and dimensions.

These variants are understood to be equally comprised in the scope of protection of the present patent, such alternative embodiments being intrinsically derivable in an obvious manner from the description provided herein of the relationship binding each embodiment with the result that the invention aims at obtaining.

1-8. (canceled)

9. A multimedia table provided with a work top (1) set up for the association with multimedia means and supported by a plurality of legs (3),
at each supporting leg (3) said work top (1) comprising the first part (4) of a bayonet fitting, separable in two parts (4, 5), the second part (5) being arranged on the facing surface of the corresponding leg (3),
one of said legs (3) being provided with wires (11, 12) extending between said second bayonet fitting part (5) and the foot of said leg (3) for the connection of said multimedia means to power supply networks available close to said leg (3), wherein said fitting device simultaneously provides both the mechanical attachment and the electric connection or the data connection.

10. The table according to claim 9, wherein said fitting comprises two mutually separable parts (4, 5), one of which is referred to as female (4) and the other is referred to as male (5).

11. The table according to claim 9, wherein said two separable parts (4, 5) are coupled to each other by means of a reciprocal axial approach.

12. The table according to claim 9, wherein said two separable parts (4, 5) are locked to each other following a relative rotation at the end of which the coupling between said component parts (4, 5) is stable and integral.

13. The table according to claim 9, wherein said part referred to as female (4) is integrally constrained to said table.

14. The table according to claim 9, wherein said leg (3) provided with wires (11, 12) has a tubular structure, and has, at the foot, a radial slot (10) in which a connector (11) for the data transmission network, a connector (12) for the electric power supply network and a protective lid (13) fixable to the leg by means of a screw are housed.

15. The table according to claim 14, wherein said data transmission connectors (11) comprise RJ45 ports.
